(19) United States
(12) Patent Application Publication
(10) Pub. No.: US 2010/0088364 A1
(43) Pub. Date: Apr. 8, 2010

(54) SOCIAL NETWORKING ARCHITECTURE IN WHICH PROFILE DATA HOSTING IS PROVIDED BY THE PROFILE OWNER

(75) Inventors: BERNADETTE A. CARTER, CARY, NC (US); ARTHUR R. FRANCIS, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/247,834

(22) Filed: Oct. 8, 2008

(51) Int. Cl. G06F 15/16; H04L 9/32

(52) U.S. Cl. 709/203; 709/217; 726/6

(57) ABSTRACT

Social networking content can be served to a set of social networking users. The served social networking content can include semantic content associated with specific ones of the social networking users. The semantic content can be shared among different ones of the social networking users during the serving. At least a portion of the semantic content can be stored within a local data store associated with a computing device of the specific user to whom the semantic content applies.

### BACKGROUND

The present invention relates to the field of social networking, more particularly to a social networking architecture in which profile data hosting is provided by the profile owner.

Social networking sites have become a new trend with new web sites across the World Wide Web. Social networking gives users the ability to interact with other users in many different fashions, including, but not limited to, sharing information about themselves, sharing user-generated content such as blogs, images, and videos, communication via a messaging system, and the like. Many users sign up for and participate in a multiple social networking sites. The users provide information to these sites about themselves to create a profile, which is shared with other users. Commonly, this content is hosted on the server hosting the social networking site. Some of the content shared in social networking sites can be private data that would not be intended for just anyone. Because the content is hosted with the owner of the social networking site, there can be concerns about how secure the data storage is, and what the owner of the site will do with the data in the future. In cases where users sign up for multiple social networking sites, their concerns are increased because they rely on more hosts to keep their data secure.

A solution is required to reduce the security concerns for data storage in social networking sites.

### BRIEF DESCRIPTION OF THE SEVERAL VIEWS OF THE DRAWINGS

FIG. 1 is a schematic diagram of a system for a social networking architecture in which profile data hosting is provided by the profile owner in accordance with an embodiment of the inventive arrangements disclosed herein.

FIG. 2 illustrates interfaces for a social networking architecture in which profile data hosting is provided by the profile owner in accordance with an embodiment of the inventive arrangements disclosed herein.

FIG. 3 is a flow chart of a method for a social networking architecture in which profile data hosting is provided by the profile owner in accordance with an embodiment of the inventive arrangements disclosed herein.

### DETAILED DESCRIPTION

The present invention can include a social networking architecture in which profile data hosting is provided by the profile owner. This architecture can be implemented in current social networking sites to allow the user's profile data to be hosted by the user on a private data server. The present invention can also allow multiple social networking sites to share the same common profile data on the privately hosted data server. In cases where a social networking site uses more information than the data provided in the common profile data, a social networking site specific profile data object can be created to include the additional information the networking site requires. This data object can be hosted on the user's data server and made accessible to the associated social networking site. The present invention can be implemented to allow a user to host their data on any computing device using any communication protocol. For example, the user can configure a web server, secure shell, FTP (file transfer protocol) server, and the like to host their profile data. The data server can have a numerous sets of access credentials. Each set of access credentials can grant different levels of access to different portions of the user's profile data. The present invention can also allow for the configuration of different access levels to a user's profile. The data server can include access credentials and each set of access credentials can be associated with a profile access level. These access levels can be configured to apply additional security settings. For example, a user can configure security settings including, but not limited to, disallowing right-clicking, encryption of the viewed profile data, masking images (adding a transparent layer above images to stop users from saving images), disabling a toolbar, disabling caching, and the like.

Each set of access credentials can be implemented using a pair of public and private encryption keys. The public key can be distributed to other users and the private key can be stored on the user's data server. This infrastructure relies on the private key being kept secure on the data server. Data can be encrypted using either key, but to decrypt the data, both keys are required. Each set of access credentials can include a public and private key, which are associated with different levels of access to the user's profile data. When another user is granted access to a certain access level to a user's profile, they can be provided with the public key associated with the granted access level.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

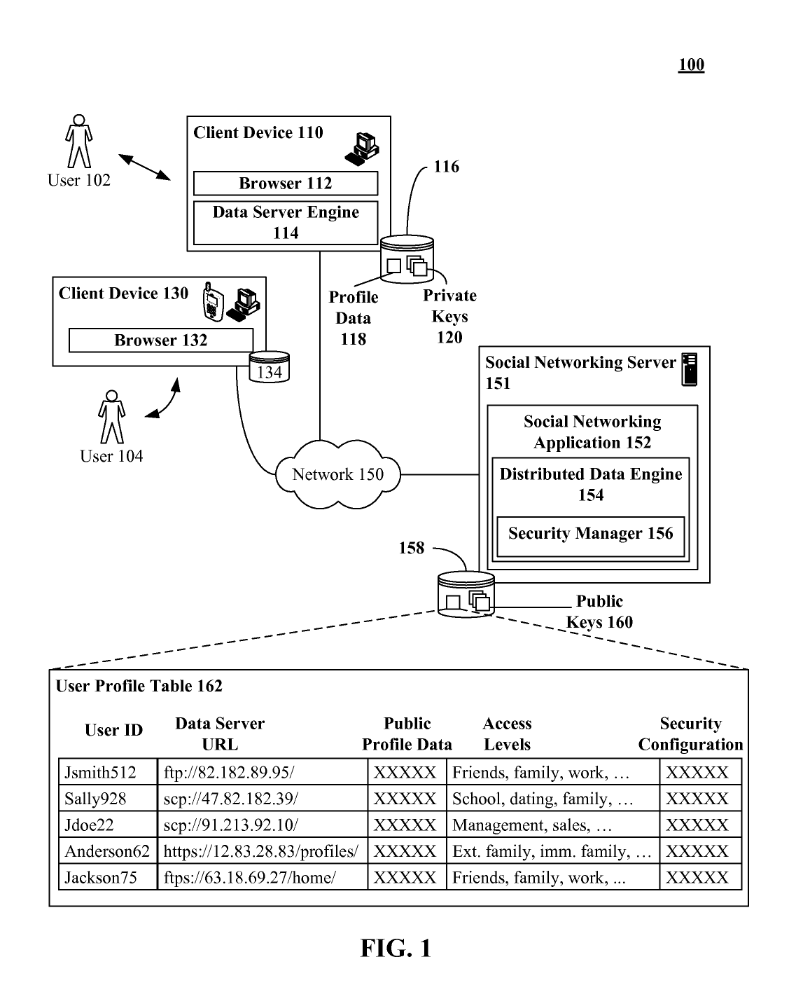

FIG. 1 is a schematic diagram of a system 100 for a social networking architecture in which profile data hosting is provided by the profile owner in accordance with an embodiment of the inventive arrangements disclosed herein. In system 100, user 102 can use browser 112 of client device 110 and user 104 can use browser 132 of client device 130 to interact with social networking server 151. Social networking server 151 can implement a social networking architecture in which profile data hosting is provided by the profile owner.

For example, user 102 can be a profile owner in which is hosting their profile data 118 on data store 116 of client device 110. User 104 can be a user of a service/Web site provided by social networking server 151. Social networking server 151 can host a set of public profile data on data store 158, as illustrated in user profile table 162. This public profile data can be served to users 102, 104 for browsing and searching user's profile data without requiring access to their private data servers.

In system 100, user 102 can utilize browser 112 to interact with social networking server 151 and create an account. User 104 can browse through the public profile data and encounter user 102's profile. User 104 can request a higher profile access level from user 102, which can require access to user 102's data server hosted on client device 110. Social networking server 151 can host a series of public keys 160 on data store 158. Public keys 160 can pair with private keys 120 to form complete access credentials to access profile data 118 on client device 110. If user 102 grants user 104 permission to view their profile data 118, social networking server 151 can provide client device 130 with the appropriate public key 160 associated with the desired access level. Client device 130 could use said appropriate public key 160 to access profile data 118 on data store 116. In one embodiment, client device 130 can store retrieved public keys 160 on data store 134 for later use.

Data server engine 114 can implement a data server on client device 110. Data server engine 114 can implement an authentication mechanism that uses public-key cryptography. This authentication mechanism can include the set of private keys 120 on data store 116, and a collection of associated public keys 160 on data store 158. When the associated keys are combined, access can be granted to profile data 118. Both keys alone are capable of encrypting data, but the data cannot be decrypted unless the public and private keys are combined. Private keys 120 can be the private portion of the encryption key pair. Public keys 160 can be the public portion of the encryption key pair.

Profile data 118 can include a set of data usable by a social networking application, such as social networking application 152. Profile data 118 can include user information such as name, address, age, location, and the like. Profile data 118 can also include user-generated content such as blog or journal posts, images, videos, and the like. Profile data 118 can be separated into different subsets of profile data. Profile data 118 can include a common set of data, which is shared between all social networking sites with access. Profile data 118 can also include data objects that are specialized data sets pertaining to certain social networking sites.

Social networking server 151 can be any computing device configured to host social networking application 152 via network 150. Social networking server 151 can implement a social networking architecture in which profile data hosting is provided by the profile owner. Social networking server 151 can be any computing device including, but not limited to, a desktop computer, a network cluster of servers, or the like.

Social networking application 152 can be an application which hosts a social networking site on social networking server 151. Social networking application 152 can provide interfaces for clients for interacting with the different implemented functions of the social networking application. For example, it can allow a user to share images, videos, blog or journal posts, and the like. Social networking application 152 can allow users to create their own profile, and search and browse other users' profiles to establish new “friends,” or a larger social network. Social networking application 152 can implement distributed data engine 154 and security manager 156 to enable profile owners hosting their own profile data.

Distributed data engine 154 can be a software enhancement for social networking application 152 to allow users to host their own profile data. Distributed data engine 154 also contains security manager 156, which can be a component to manage public keys 160 associated with users' data servers. Security manager 156 can be a software component responsible for managing the collection of public keys 160. Security manager 156 can be responsible for establishing each access level and determining which public keys users currently have. Security manager 156 can allow for the application of access level specific security settings specified by the user.

User profile table 162 can illustrate data stored on 158 for use by social networking application 152. User profile table 162 can include fields user ID, data server URL (uniform resource locator), public profile data, access levels, and security configuration. The user ID field can be used to store the user's unique login name. The data server URL field can be a formatted address to access the user's data server. The public profile data field can be used to store a portion of the user's profile data that is marked as public. This data can also be indexed for quick searching. The access levels field can be used to store the defined access levels for the data server. Each access level can be associated with a different public key 160, which can pair with a private key 120 to form complete credentials for the user's data server. The security configuration field can be used to store security settings associated with each user access level.

Client devices 110 and 130 can be any computing device capable of communicating with social networking server 151 via network 150. Client device 110 can be configured as a data server to host profile data 118 on data store 116. Client device 110 can use browser 112 to interact with social networking application 152. Client device 130 can use browser 132 to interact with social networking application 152. Client devices 110 and 130 can include, but are not limited to, a laptop, a desktop computer, a mobile phone, a personal data assistant (PDA), a gaming console, or the like.

Data stores 116, 134, and 158 can be physically implemented within any type of hardware including, but not limited to, a magnetic disk, an optical disk, a semiconductor memory, a digitally encoded plastic memory, a holographic memory, or any other recording medium. The data stores 116, 134, and 158 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

It should be appreciated that derivatives and deviations from the arrangements shown in system 100 are contemplated. For example, in one embodiment, the data server engine 114 can be located on a device other than the client device 110, such as a network element having access to data store 116. In one embodiment, profile data 118 can be unencrypted (no need for public-private key encryption/decryption), where links to the data 118 is still maintained by server 151. In an embodiment without encryption, the profile data 118 can still be easily shared and used for multiple social networking servers 151 and a user 102 can maintain a level of control of the data 118 by being able to add/delete the content of data store 116. In one embodiment, the private data 118 can be directly shared among different client devices 110, 130 without conveyance of the data 118 to server 151 being required. For example, client-side software (e.g., peer-to-peer software) can permit a sharing of the profile data 118 while optional tools, Web services, etc. provided by server 151 can facilitate the direct sharing of the data 118.

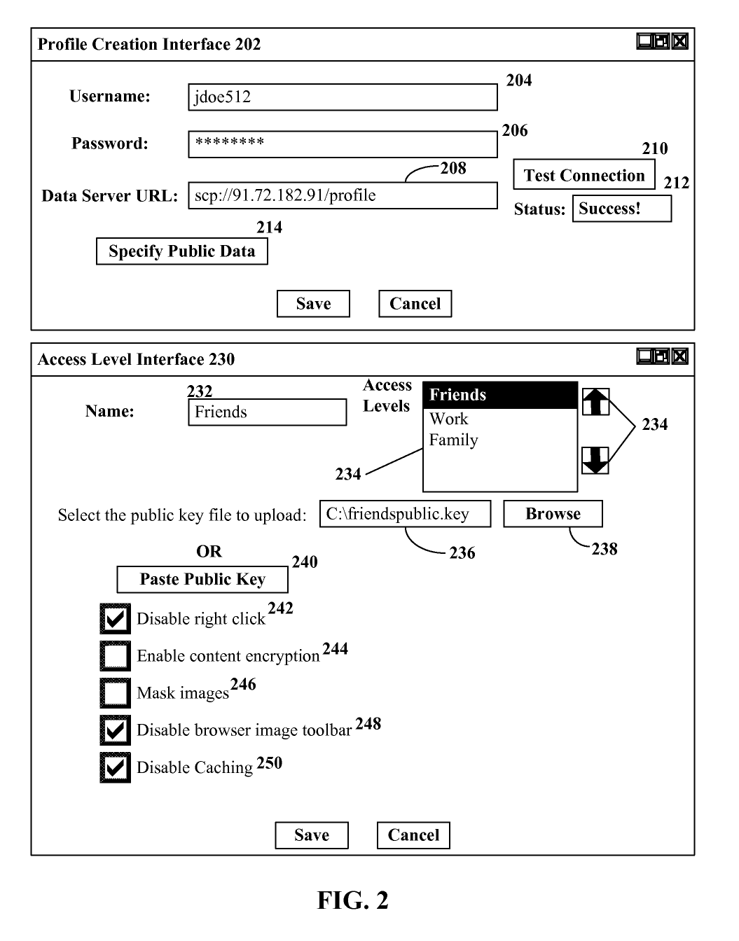

FIG. 2 illustrates interfaces 202, 230 for a social networking architecture in which profile data hosting is provided by the profile owner in accordance with an embodiment of the inventive arrangements disclosed herein. The interfaces 202, 230 are provided for illustrative purposes only and the disclosure is not to be construed as limited to the arrangements shown. Further, although GUI interfaces are shown, other interfaces, such as voice user interfaces (VUIs), text user interfaces (TUIs), etc., are contemplated. The interfaces 202, 230 can be provided in context of system 100.

Profile creation interface 202 can illustrate part of the procedure for creating a new profile on a social networking site in which profile data is hosted by profile owner. Profile creation interface 202 can include controls 204 and 206 to allow a user to specify a username and password for their account on the social networking site. Control 208 can allow the user to specify the URL to access their data server. The provided URL can be formatted to include the protocol, address, and path to the data server. For example, http://28.81.92.83/my_profile, wherein HTTP (hypertext transfer protocol) is the protocol, 28.81.92.83 is the IP (internet protocol) address of the server, and my_profile is the path in which is the data can be found. Control 210 can allow the user to test the connection to their data server before proceeding. Display 212 can notify the user of the status of the connection test. Control 214 can act as an additional interface (not shown) to specify public data that can be stored on the social networking server, to allow other users to search through. It is contemplated that before proceeding with the profile creation, a successful connection test can be required.

Access level interface 230 can be an interface that can be used to configure the social networking site with the different access levels, which are configured on the user's data server. Each access level can be associated with a different public key that can be provided to the social networking server. List control 234 can be a list of the currently added access levels. As illustrated, the “Friends” access level is currently selected. Arrow controls 234 can be used to select a different access level for modification. Name control 232 can allow the user to name the current access level. Controls 236 and 238 can be a file selection control, wherein control 236 displays the path to the currently selected file, and control 238 can activate a dialog to allow the user to browse their accessible storage locations for a file to upload. When a file is selected, control 236 can be updated to display the path to the selected file. These controls can be used to specify a public key to upload for the current access level. Control 240 gives the user the ability to paste the public key instead of uploading a file containing it (as the storage of the file may be insecure). Controls 242-250 can allow the specification of individual security settings for displaying content to the current access level. Control 242 can toggle the disablement of right-clicking on the content (i.e., so a user cannot right-click and save an image). Control 244 can enable the encryption of the displayed content. If this access level is configured to access a portion of profile data in which contains sensitive information, it may be preferred to enable encryption to avoid interception of the data. Control 246 can toggle the enablement of image masking. Image masking can allow a transparent layer to be created on top of displayed images. When this layer is present, if a user attempts to save the image, they will save the transparent image instead. Control 248 can toggle the disablement of the browser image toolbar. Control 250 can toggle the disablement of browser caching when browsing the shared content.

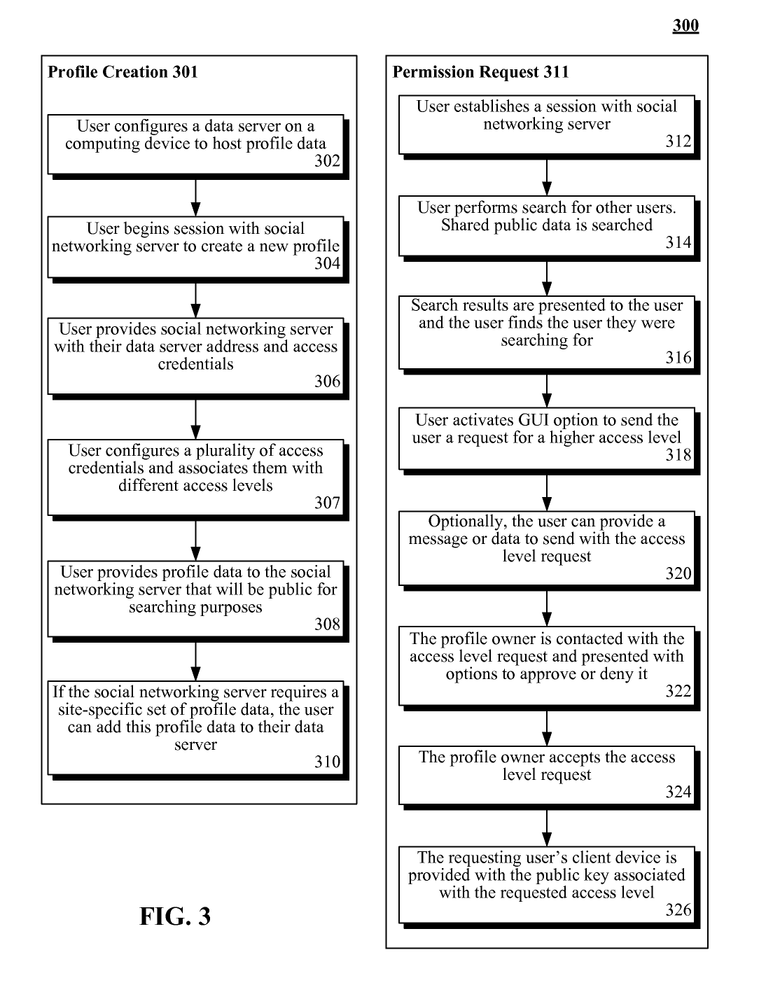

FIG. 3 is a flow chart of a method 300 for a social networking architecture in which profile data hosting is provided by the profile owner in accordance with an embodiment of the inventive arrangements disclosed herein. Method 300 can be performed in context with system 100. Method 300 can include two separate situations, profile creation 301 and permission request 311.

Profile creation 301 can be performed in the situation where a user is creating a new profile using a social networking architecture in which profile data can be hosted by the profile owner. Profile creation 301 can begin in step 302, where a user can configure a data server on a computing device to host profile data. The data server can implement any standard communication protocol that supports file transfer, including, but not limited to, file transfer protocol (FTP), FTP over secure sockets layer (SSL) (FTPS), secure copy (file transfer via SSH, or secure shell), HTTP (hypertext transfer protocol), and the like. In step 304, the user can begin a session with a social networking server to create a new profile. In step 306, the user can provide the social networking server with the data server's address and access credentials. In step 307, the user can configure a plurality of access credentials and can associate them with different access levels. In step 308, the user can specify some profile data as public and provide a copy of it to the social networking server for searching purposes. In step 310, if the social networking server requires a site-specific set of profile data, the user can add this profile data to their data server. The user can host profile data for a plurality of social networking sites simultaneously. Certain sites may take advantage of profile data that other sites do not and may require more profile data than is commonly hosted to all social networking sites. In these cases, the user can be given the option to enter this information and save it on their data server for use on the site.

Permission request 311 can be performed in the situation in which a user is searching for a user to retrieve access to their profile using a social networking architecture in which profile data can be hosted by the profile owner. Permission request 311 can begin in step 312, where a user can establish a session with a social networking server. In step 314, the user can perform a search for other users in which their shared public profile data is searched. In step 316, search results are presented to the user and the user can find the user they were looking for. In step 318, the user can activate a graphical user interface (GUI) option to send the user a request for a higher access level. In step 320, optionally, the user can provide a message or data to send with the access level request. In step 322, the profile owner can be contacted with the access level request and presented with options to approve or deny it. In step 324, the profile owner accepts the access level request. In step 326, the requesting user's client device can be provided with the public key associated with the requested access level.

In one embodiment, access rights to a profile can span multiple different social networking systems. These different social network systems can optionally trust permissions established with other social networking sites. For example, a user may be verified and authorized by SocialNetA as being able to access private social networking data, such as that stored and access controlled locally by a portion of the users of SocialNetA. A different social networking system, SocialNetB, can have an agreement with SocialNetB, where verified users granted access to privately maintained data in one network are granted approximately equivalent access rights in the other.

In one embodiment, users of either system who maintain locally stored social networking data, can selectively opt in or opt out of the access sharing process/policy. For example, a configurable option to “auto-accept upon authentication” and an option to “authenticate across networks can be enabled. This can permit a user of SocialNetA and SocialNetB, who has been authenticated as having access to LocalSocialNetDataA by SocialNetA, to be granted equivalent access to LocalSocialNetDataA, when utilizing SocialNetB.

In another embodiment, an authentication server and/or process that is independent of any social networking system, can exist which provides access to locally stored profile data to any authorized social network. In one implementation, the shared social networking systems can be restricted to a set of systems, which a user who locally maintains profile data utilizes and/or has explicitly approved. Database engines can maintain associations between different user identifies of the different sites, which may require some level of user data verification to avoid potential security issues.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for social networking comprising:
serving social networking content to a plurality of social networking users, wherein the served social networking content comprises semantic content associated with specific ones of the social networking users, wherein the semantic content is shared among different ones of the social networking users during the serving, wherein at least a portion of the semantic content is stored within a local data store associated with a computing device of the specific user to whom the semantic content applies.

2. The method of claim 1, wherein a second portion of the semantic content is stored in a centralized data repository of a social networking server.

3. The method of claim 2, wherein the centralized repository comprises non-confidential semantic content, and wherein the local data store comprises at least one of private semantic content, confidential semantic content, and user encrypted semantic content.

4. The method of claim 1, further comprising:
sharing semantic content stored in the local data store with a plurality of different social networking systems, each of which are configured to serve the social networking content to a plurality of social networking users; and
utilizing authentication credentials established with one of the different social networking systems to determine access to the local data store that is to be granted to users of another one of the different social networking systems.

5. The method of claim 4, further comprising:
encrypting semantic content stored in the local data store; and
storing a decryption key for the semantic content within the centralized repository, wherein the decryption key is indexed against a network address of the local data store.

6. The method of claim 4, further comprising:
indexing the network addresses and the decryption keys against social networking user identifiers.

7. The method of claim 1, further comprising:
configuring in a social networking server a plurality of access credentials to be associated with different levels of access to the shared semantic content including the portion of the semantic content stored in the local data store.

8. The method of claim 1, further comprising:
configuring the social networking application with each set of access credentials and their access levels; and
associating each configured access level with a set of security settings applied when serving the semantic content.

9. The method of claim 8, wherein one of the security settings disallow a user to right-click when viewing the semantic content of the local data store.

10. The method of claim 8, wherein one of the security settings enable encryption of the semantic content of the local data store.

11. The method of claim 8, wherein one of the security settings mask images in the semantic content of the local data store by rendering a transparent layer over the images, thereby preventing a user from saving the semantic content.

12. The method of claim 8, wherein one of the security settings disable a browser toolbar in the user's browser application in which is browsing the semantic content of the local data store.

13. The method of claim 8, wherein one of the security settings disable the browser caching of the semantic content of the local data store.

14. A computer program product for social networking comprising: a computer usable medium having computer usable program code embodied therewith, the computer usable program code comprising:
computer usable program code configured to serve social networking content to a plurality of social networking users, wherein the served social networking content comprises semantic content associated with specific ones of the social networking users, wherein the semantic content is shared among different ones of the social networking users during the serving, wherein at least a portion of the semantic content is stored within a local data store associated with a computing device of the specific user to whom the semantic content applies.

15. A social networking system comprising;
a social networking server configured to serve social networking content to a plurality of client devices used by a plurality of social networking users, wherein the served social networking content comprises semantic content associated with specific ones of the social networking users; and
at least one data store configured to digitally store at least a portion of the semantic content shared with the social networking users via the social networking server, wherein the data store is remotely located from the social networking server and is owned and controlled by the specific user to whom the semantic content applies.

16. The social networking system of claim 15, further comprising;
a data server engine disposed in at least one of the client devices having access to the one of the at least one data stores, wherein the data server engine is configured to serve semantic content of the data store, and wherein the data server engine is configured to respond to requests of the social networking server.

17. The social networking system of claim 15, wherein each data store is a data store of a specific one of the client devices.

18. The social networking system of claim 17, wherein the at least one data store comprises a plurality of data stores, and wherein each of the client devices has an associated data store.

19. The social networking system of claim 17, further comprising:
a social networking data store associated with the social networking server configured to store data addresses for accessing the data stores associated with the client devices.

20. The social networking system of claim 19, wherein the semantic content of the data store is encrypted, wherein the social networking data store stores an encryption key for accessing each of the data stores associated with client devices.
